(19) United States
(12) Patent Application Publication
(10) Pub. No.: US 2014/0180822 A1
(43) Pub. Date: Jun. 26, 2014

(54) TARGETED MOBILE ADVERTISING AND SYSTEM THEREFOR

(71) Applicant: ITXC IP Holdings S.a.r.l., Luxembourg (LU)

(72) Inventors: Brian Peebles, Cranford, NJ (US); Ning So, Plano, TX (US)

(73) Assignee: ITXC IP Holdings S.a.r.l., Luxembourg (LU)

(21) Appl. No.: 14/017,713

(22) Filed: Sep. 4, 2013

Related U.S. Application Data
(63) Continuation-in-part of application No. 13/724,956, filed on Dec. 21, 2012.

(51) Int. Cl. G06Q 30/02

(52) U.S. Cl. CPC G06Q 30/0267
USPC 705/14.64

(57) ABSTRACT

A mobile advertising exchange and method includes a data processing system that receives notification of a potentially ad-triggering event associated with a mobile subscriber, generates an advertising package including filtered mobile subscriber data, transmits the advertising package to an advertising entity, and receives fee from the first advertising entity.

### STATEMENT OF RELATED CASES

This case is a continuation-in-part of U.S. patent application Ser. No. 13/724,956, which was filed on Dec. 21, 2012 and is incorporated herein by reference. If there are any contradictions or inconsistencies in language between this application and the case that has been incorporated by reference that might affect the interpretation of the claims in this case, the claims in this case should be interpreted to be consistent with the language in this case.

### FIELD OF THE INVENTION

The present invention relates to wireless telecommunications, and more particularly to mobile advertising.

### BACKGROUND OF THE INVENTION

Mobile advertising is the process of delivering advertisements to mobile devices. Mobile ads appear in a variety of forms, including a mobile web banner (appearing at the top of a page), a mobile web poster (appearing at the bottom of a page), SMS advertising, MMS advertising, advertising within mobile games and videos, interstitials that appear while a requested item of mobile content or web page is loading, or a jingle before a voicemail recording. It is estimated that on a global basis, mobile advertising will grow from US$6 billion in 2011 to US$28.8 billion in 2016. The number of users who access the Internet via mobile devices exclusively is expected to triple from 18 million to 55 million in the five year period between 2011 and 2016.

Most internet and mobile advertising relies on behavioral targeting to identify ad recipients. In the desktop (computer) environment, advertisers are able to target potential customers based on profiles developed using third-party cookies. The more web sites that a user visits, the more cookies the user's desktop accumulates, enabling an advertiser to develop a composite sketch of the user. With such a profile in hand, the advertiser has greater confidence that an ad sent to any particular user will have greater relevance than would otherwise be the case. But this tool (i.e., third-party cookies) is generally not available for mobile advertising. Apple's mobile operating system (iOS) rejects third-party cookies, which makes it very difficult to track a user on an iOS device. Google's Android platform was modeled after iOS, but it does provide some support for third-party cookies.

As a consequence, behavioral targeting for mobile advertising relies on location-based techniques, such as geo-aware targeting, place-based targeting, and geo-fencing to target potential customers. The theory is that location-based advertising enables targeting a customer that is near to the advertiser's business. Geo-aware targeting employs real-time location data, which is supplied by the mobile provider. Using this data, an advertiser can send an ad to a potential customer's mobile device when the customer is near to a certain location. In place-based targeting, an advertiser sends mobile advertisements to mobile users in a certain area or location at a specific time frame. For example, an advertiser of a sports-related item might choose to send an ad to all mobile devices that are in the vicinity of a soccer stadium during a game. Geo-fencing enables advertisers to target users within a pre-determined region based on latitude and longitude data. This can be used, for example, to create a virtual fence having a certain radius extending from a point of interest to the advertiser—such as the advertiser's store. This can be used to drive foot traffic to the store, such as by providing a coupon, etc.

A recent thrust in mobile advertising is to collect user place-visit history, such as via Wi-Fi fingerprinting. This information is used to generate a model for predicting a user's next stop based on where the user has most recently been. The goal is to be able to identify a mobile user having the intent to buy something when they are in a location in which they can actually make the purchase.

Yet, behavioral targeting has its limitations and a need remains for an improved approach for targeting ad recipients.

### SUMMARY OF THE INVENTION

The present invention provides a new approach to mobile advertising that is expected to increase the return on advertising dollars for the advertiser, offer the promise of better customer retention and potentially more revenue for the mobile network operator, and result in reduced fees for the mobile subscriber.

The illustrative embodiment of the present invention is a Mobile Advertising Exchange that provides advertisers with access to mobile subscriber information that has been generally unavailable to any party but the mobile subscriber's home network.

A mobile network operator (“MNO”) keeps detailed records about its mobile subscribers. These records include account information, user device information, personal information, and usage records. Such information would be of keen interest to an advertiser, since it is likely to enable the advertiser to develop a very detailed profile of a potential customer. Whether to supplement “behavioral” information or supplant it, this type of subscriber information, in the hands of an advertiser, is expected to substantially improve the advertiser's ad-targeting ability. But due to privacy and other concerns, these records have been tightly controlled by the mobile subscriber's home MNO and are generally not accessible to any other party.

In accordance with the illustrative embodiment, access to this hitherto private information enables an advertiser to identify, from a general population of mobile subscribers, those that satisfy certain criteria, as established by the advertiser and gleaned from the subscriber records. Assuming the criteria are well chosen, the advertiser can expect an increased hit rate when sending ads to the identified subscribers. In other words, this “targeted” audience should be more likely to respond positively to the ad than if it were broadcast to a random group of subscribers based solely, for example, on their presence at a particular location or based on a visit to a website through their mobile device. In considering this additional subscriber information, the present approach goes beyond the behavioral targeting practiced in the prior art.

To implement this capability, in the illustrative embodiment, the Mobile Advertising Exchange comprises a mobile-subscriber Records Exchange System. The Record Exchange System is implemented as a data processing system, including a transceiver, a processor, and processor-accessible storage. As discussed further below, the Records Exchange System enables at least some of the typically private mobile subscriber information to be transmitted to an advertiser.

The architecture and use of the Mobile Advertising Exchange is summarized here by way of the following non-limiting example. Consider a mobile subscriber that is shopping for a television in a local electronics store. Having identified a television for possible purchase, the subscriber wishes to do some price/comparison shopping. The mobile subscriber scans a bar code or QR code of the television via a third party APP installed on the subscriber's mobile device.

The mobile subscriber's behavior—the bar code scan—is referred to herein as a “potentially ad-triggering event.” Other examples of potentially ad-triggering events include, without limitation, the presence of a mobile subscriber at a certain location, a mobile subscriber accessing a certain website, a mobile subscriber downloading certain software, a mobile subscriber doing on a search for a particular item/place, etc. The event is “potentially” ad triggering because, in the illustrative embodiment, the decision by an advertiser to actually send an ad to the mobile subscriber is not based solely on the occurrence of the event itself.

Returning to the example, the subscriber's scan or use of the APP is detected by the home MNO, such as via another APP on the subscriber's mobile device or via deep packet inspection. The home MNO checks the subscriber's record to see if the subscriber has “opted-in” to the Mobile Advertising Exchange. In the illustrative embodiment, an advertiser cannot deliver an ad to a mobile subscriber unless the subscriber has opted-in to the system, thereby giving explicit permission to be part of this mobile advertising process. Opt-in or some other form of permission on the part of the mobile subscriber may be required because, as part of the Mobile Advertising Exchange, private information concerning the subscriber may be sent to an advertiser. In the illustrative embodiment, the home MNO must have previously “opted-in” to the Mobile Advertising Exchange as well.

In the illustrative embodiment, the subscriber may receive a benefit for opting in to the Mobile Advertising Exchange. The benefit can be, for example and without limitation, a credit on the subscriber's wireless bill, placing the subscriber on a “plan” that has lower-than-normal rates for wireless service, or other types of incentives (e.g., extra data usage, etc.). This benefit is subsidized by the advertiser, which has paid a fee to the MNO for access to the records of its subscribers.

Continuing with the example, if the subscriber has opted-in to the Mobile Advertising Exchange, the MNO reports (transmits an information-bearing signal) to the Mobile Advertising Exchange. In some embodiments, the information includes some information about the potentially ad-triggering event (e.g., the fact that the mobile subscriber is shopping for TVs, the scanned bar code itself, etc.) and an identifier for the mobile subscriber and/or the subscriber's home MNO. The actual identity of the mobile subscriber is typically protected; the identifier is the Temporary Mobile Subscriber Identity (“TMSI”), or the like, or, alternatively, “de-identification technologies” can be used to protect the actual identity of any particular mobile subscriber.

The Mobile Advertising Exchange receives the signal from the MNO and extracts the information therefrom. In some embodiments, the Mobile Advertising Exchange then transmits a message to one or more advertisers that have joined the Mobile Advertising Exchange. The message advises the advertisers of the availability of an “Advertising Package” for the mobile subscriber that triggered the process. As discussed further below, the Advertising Package includes otherwise private demographic and/or other information pertaining to the mobile subscriber and, in some embodiments, information pertaining to the potentially ad-triggering event.

It is advantageous, from an advertiser's perspective, to have some way of determining whether the Advertising Package will be of interest, since, depending upon the arrangement, the advertiser might have to pay for the Advertising Package. To this end, in some embodiments, the message transmitted to the advertisers advising of the availability of the Advertising Package includes some accompanying basic information about the subscriber to assist the advertiser in determining whether it has an interest in obtaining the Advertising Package.

In some other embodiments, the advertisers advise the Mobile Advertising Exchange, in advance, of an archetype of a mobile subscriber of interest. That is, the advertiser advises the Mobile Advertising Exchange of certain subscriber characteristics (e.g., demographics, etc.). In some embodiments, the Mobile Advertising Exchange then generates a table that identifies opt-in mobile subscribers that satisfy the advertiser's criteria. Thus, when the Mobile Advertising Exchange receives the signal from the MNO, it can determine whether the mobile subscriber in question would be of interest to the advertiser. If so, the Mobile Advertising Exchange can transmit a message to the advertiser(s).

In some embodiments, no information about the mobile subscriber is transmitted in the message that advises of the availability of the Advertising Package. In such embodiments, the message will include information pertaining to the potentially ad-triggering event and the home MNO of the subscriber.

In some embodiments, the Mobile Advertising Exchange conducts an auction for the Advertising Package of the mobile subscriber. Advertisers that have received a message concerning the availability of the Advertising Package can then choose to submit a bid for the Advertising Package. The Mobile Advertising Exchange determines the winning bid and awards the auction to the advertiser that submitted it.

In some other embodiments, an auction is not conducted. Rather, advertisers pay to receive an Advertising Package; there is no competition for the Package. After reading this disclosure, those skilled in the art will be able to develop any of a variety of arrangements whereby an advertiser can bid on Advertising Packages or purchase the right to receive an Advertising Package for certain “archetype” mobile subscribers (e.g., those exhibiting certain demographics, those exhibiting certain behaviors (e.g., comparison shopping on bicycles, etc.).

As previously indicated, the Advertising Package includes some information pertaining to the mobile subscriber. Such information is ultimately sourced from the mobile subscriber's home MNO. In particular, in the illustrative embodiment, the Record Exchange System within the Mobile Advertising Exchange receives selected mobile subscriber records that are transmitted from the subscriber's MNO via, for example, the Internet. In some embodiments, the Record Exchange System stores the mobile subscriber records in a block of secure storage. Each mobile network operator that utilizes the Records Exchange System is allocated its own block of secure storage within the processor-accessible storage. The selected mobile subscriber records can be transmitted to the Records Exchange System at any convenient time, such as when a mobile subscriber opts-in, when a subscriber causes a potentially ad-trigger event, after an advertiser wins an auction for the Advertising Package associated with a subscriber, etc.

The information about the mobile subscriber that becomes part of the Advertising Package is typically a subset of the information that is stored in the Records Exchange System. The information in the Advertising Package is generated by specialized software that “filters” the mobile subscriber records so that only certain information is revealed to the advertiser. To support mobile advertising when a subscriber is roaming, the method also contemplates creating filtered records for “visited” MNOs. Thus, parties that might receive the filtered mobile subscriber data include, without limitation, other mobile network operators (to support broadband roaming) as well as any entity involved in mobile advertising, such as, without limitation, a mobile advertising network, a mobile agency, a mobile advertising publisher, a store, a website, etc. A mobile network operator may wish to advertise as well. The term “Advertising Entity” is used hereinafter to refer to any type of entity wishing to advertise or otherwise involved in mobile advertising.

The information that is contained in the filtered mobile subscriber records depends on, among other considerations, the party that will receive those records. It can also depend upon the particular mobile subscriber. In some embodiments, to use the Records Exchange System, an MNO establishes records exchange agreements with other third parties using the System. These agreements establish a framework for interaction between the MNO and every third party wishing to receive filtered mobile subscriber data from the Mobile Advertising Exchange. In some other embodiments, exchange agreements are “automatically” established once a party opts-in to the Mobile Advertising Exchange. In yet some further embodiments, if exchange agreements are not established among one or more parties, a default agreement is established that permits some limited amount of information to be exchanged as between those parties.

Based on these agreements, “data exchange packages” (“DEPs”) are established. The data exchange packages define, among other items, what particular information within the mobile subscriber record that is available to the Records Exchange System of the Mobile Advertising Exchange (as provided by the mobile network operator) can be forwarded to any particular third party. In other words, the data exchange packages function as a “filter” so that some, but usually not all, of the information contained in the subscriber's record winds up in a “filtered” record destined for a third party. The filtered record provides an Advertising Entity, for example, with the information needed or desired to make a decision as to whether it wishes to send the associated mobile subscriber an ad.

For example, the DEP might indicate that for all shopping comparison activities, the location of the user (i.e., name of the store), user demographics (e.g., age group, gender, etc.), device demographics (device maker/model), past ad click-through rate, etc., are to be included in the filtered record.

Continuing with the example, the filtered information and information pertaining to the potentially ad-triggering even are bundled together to form the Advertising Package. The Advertising Package is then transmitted from the Mobile Advertising Exchange to the appropriate Advertising Entity(ies). The advertising entity then reviews the information and determines whether to send an ad to the mobile subscriber.

In some embodiments, the Mobile Advertising Exchange includes an ad server for serving ads to a mobile subscriber. The ad can be a mobile web banner (appearing at the top of a page), a mobile web poster (appearing at the bottom of a page), SMS advertising, MMS advertising, advertising within mobile games and videos, interstitials that appear while a requested item of mobile content or web page is loading, or a jingle before a voicemail recording. In some other embodiments, the ad server is associated with the Advertising Entity or a third party “publisher.”

The Exchange can be used to deliver ads to a mobile subscriber while in the home network or even when the mobile subscriber is roaming in another (“visited”) network. By permitting another network to benefit from the presence of a mobile user roaming therein, that network is less likely to be inclined to poach the user.

To support mobile advertising when a subscriber is in a visited network, the visited network is provided access to filtered mobile subscriber records. This enables and requires the visited MNO to enforce the agreed-upon policies on roaming subscribers. The filtered records that are provided to the visited MNO are likely to include different information that those provided to Advertising Entities (assuming that the visited MNO is not the Advertising Entity). And that implicitly gives the home MNO a greater measure of control over its subscribers than would otherwise be the case. Furthermore, the detailed information available in the filtered mobile subscriber records might provide the visited MNO with some insight into services that might be of interest to a roaming mobile subscriber. The information provided in the filtered mobile subscriber records thus effectively enables enhanced cooperation between networks that may tend to decrease the tendency for a visited network to attempt to poach another network's mobile subscriber.

The elapsed time for process described above, from the potentially ad-triggering event until the time an ad is served is typically less than 1 second.

In some embodiments, a method in accordance with the disclosure comprises:
receiving, at a data processing system, notification of a potentially ad-triggering event associated with a mobile subscriber who is associated with a first mobile network;
generating, in the data processing system, an advertising package, wherein the advertising package includes first filtered mobile subscriber data pertaining to the mobile subscriber;
transmitting, from the data processing system, the advertising package to a first advertising entity; and
receiving, at the data processing system, a first fee from the first advertising entity.

The foregoing summary provides a few embodiments of the present invention;

additional embodiments are depicted in the appended Drawing and the following Detailed Description and the claims.

### BRIEF DESCRIPTION OF THE DRAWINGS

FIG. 1 depicts Mobile Advertising Exchange 100 in accordance with the illustrative embodiment of the present invention.

FIG. 2 depicts a block diagram of an illustrative hardware platform for the Mobile Advertising Exchange of FIG. 1.

FIG. 3 depicts content within processor-accessible storage of a Records Exchange System of the Mobile Advertising Exchange of FIG. 1.

FIG. 4 depicts further details about the content of processor-accessible storage shown in FIG. 3.

FIG. 5A depicts a flow diagram of method 500A in accordance with the illustrative embodiment of the present invention.

FIG. 5B depicts a flow diagram of method 500B by which an Advertising Entity interacts with the Mobile Advertising Exchange.

FIGS. 6A-6D depict sub-tasks for use in some embodiments of the method of FIG. 5A.

FIG. 7 depicts a method for filtering mobile subscriber records, in accordance sub-task 605 of task 502 of the method of FIG. 5A.

FIGS. 8-12 depict an example of the use of the Mobile Advertising Exchange.

### DETAILED DESCRIPTION

Certain terms/phrases will be explicitly defined, when and where context permits, in this Detailed Description. Such definitions are to be used for the interpretation of these terms/phrases, and their inflected forms, as used herein and in the appended claims. Furthermore, the following acronyms may appear in the description and are reproduced below for convenience:
“DEP” for data exchange package;
“FMSR” for filtered mobile subscriber record;
“MEO” for mobile exchange operator (and used synonymously with Records Exchange System);
“MNO” for mobile network operator;
“MSR” mobile subscriber record;
“RAP” for record abstraction process; and
“SRK” for secure records keeper.

FIG. 1 depicts Mobile Advertising Exchange 100, network 102, two mobile network operators MNO-1 and MNO-2 and three Advertising Entities AE-1, AE-2, and AE-3 that potentially utilize system 100.

An MNO operates a wireless voice network and typically a wireless data network for providing wireless service to subscribers, in well-known fashion. Examples of MNOs include Verizon Wireless, AT&T Mobile, and the like. The terms “mobile network operator” or “MNO” and “mobile network” will be used somewhat interchangeably herein. In some passages, the distinction between “operator” and “network” is not apparent. In other passages, it will be apparent that it is the “network” or the “operator” of the network, which is being referenced. No particular significance is to be attached to the use herein one or the other of these terms.

MNO-1 provides wireless service (voice and/or data) to mobile stations (e.g., cell phones, etc.)/mobile subscribers (hereinafter simply “mobile subscriber(s)”) MS1-1 and MS1-2. Mobile subscribers MS1-1 and MS1-2 are but two of many mobile subscribers MS1-i, i=1, p, of MNO-1. Likewise, MNO-2 provides wireless service to a large number of its mobile subscribers as well as subscribers of other networks, such as MS1-2, to the extent that MS1-2 roams in MNO-2.

Advertising entities AE-1, AE-2, and AE-3 are any type of business, organization, etc., involved in mobile advertising, such as and without limitation, any entity wishing to advertise, a mobile advertising network, a mobile agency, an mobile ad publisher, a store, a website, etc. In fact, an MNO can be an advertiser. The term “Advertising Entity” is used hereinafter to refer to any type of entity (including an MNO) wishing to advertise to a mobile user or otherwise involved in mobile advertising. It will be understood that virtually any number of MNOs or Advertising Entities can utilize Mobile Advertising Exchange 100.

As depicted in FIG. 1, Mobile Advertising Exchange 100 includes Records Exchange System 101. The Records Exchange System is a data processing system that enables information to be securely exchanged between parties that have opted-in to the Mobile Advertising exchange, such as MNO-1, MNO-2, and AE-1, AE-2, and AE-3, which would not normally share such information. The information being exchanged between Records Exchange System 101 and such parties will include information pertaining to mobile subscribers (e.g., account information, device information, personal information, etc.) of one or more MNOs. Further description of Records Exchange System 101, including an illustrative implementing hardware platform and the operation of the system, is provided later in this specification.

In the illustrative embodiment, Mobile Advertising Exchange 100 is owned and/or operated by an Exchange operator that is independent of any of the parties using the Exchange. In some other embodiments, at least one such user will have at least a partial ownership interest or operational responsibility in Mobile Advertising Exchange 100.

Network 102 is one or more data networks, such as the Internet. Information, such as mobile subscriber information, is transmitted between the various parties and Mobile Advertising Exchange 100 via network 102 and through respective bilateral wired or wireless telecommunications links by which the parties and Mobile Advertising Exchange 100 access network 102.

FIG. 2 depicts a block diagram of the salient components of an illustrative hardware platform for implementing Mobile Advertising Exchange 100 of FIG. 1. In the embodiment depicted in FIG. 2, Mobile Advertising Exchange 100 is a data processing system comprising transceiver 206, one or more processors 208, and processor-accessible storage 210, interrelated as shown.

In the illustrative embodiment, processor 208 is a general-purpose processor that is capable of, among other tasks, running Operating System 212, executing Specialized Application Software 214, and populating, updating, using, and managing Records 216 in processor-accessible storage 210. In some alternative embodiments of the present invention, processor 208 is a special-purpose processor. It will be clear to those skilled in the art how to make and use processor 208.

Processor-accessible storage 210 is a non-volatile, non-transitory memory technology (e.g., hard drive(s), flash drive(s), etc.) that stores Operating System 212, Specialized Application software 214, and Records 216, whether of an intermediate or archival nature. It will be clear to those skilled in the art how to make and use alternative embodiments that comprise more than one memory, or comprise subdivided segments of memory, or comprise a plurality of memory technologies that collectively store Operating System 212, Specialized Application Software 214, and Records 216.

Transceiver 206 enables Mobile Advertising Exchange 100 to (i) transmit information-conveying signals to network 102 for transmission, ultimately, to the entities using the system and (ii) to receive information-conveying signals from network 102, which are typically ultimately sourced from such entities. It will be clear to those skilled in the art, after reading this specification, how to make and use transceiver 206.

It is to be understood that FIG. 2 depicts one embodiment of a data processing system that implements Mobile Advertising Exchange 100; a variety of other hardware platforms or arrangements can suitably be used. For example, Exchange 100 can be implemented in a virtual computing environment. In some embodiments, multiple processors can be used, wherein different processors execute different Specialized Application Software programs. The use of multiple processors may be advantageous or necessary as a function of the amount of data (e.g., mobile subscriber records, etc.) being processed by Mobile Advertising Exchange 100.

Furthermore, in some embodiments of Mobile Advertising Exchange 100, the various elements depicted in FIG. 2 are co-located with one another. In some other embodiments, one or more of the elements is not co-located with the remaining elements. For example, in some embodiments, processor-accessible storage 210 is not co-located with processor 208. And as previously disclosed, processor-accessible storage 210 can be multiple separate memories, one or more of which can be physically remote from processor 208. For instance, in some embodiments, the mobile subscriber information for subscribers of a particular MNO (which in the illustrative embodiment is contained in Records 216) can be stored in a memory that is hosted at the premises of that MNO whereas other information contained in Records 216 can be stored in a memory hosted elsewhere (e.g., at the premises of the Mobile Advertising Exchange operator, etc.).

FIG. 3 depicts, for the illustrative embodiment, further detail about the contents of processor-accessible storage 210. As depicted in FIG. 3, Records 216 includes:
Data Exchange Packages 340-i,j;
Mobile Subscriber Records 342-i,k;
Mobile Subscriber Opt-in List 346;
Participating Entity List 348.

In accordance with the illustrative embodiment, an MNO wishing to avail itself of the services provided by Mobile Advertising Exchange 100 “opts-in.” In some embodiments, the MNO pays a fee to the operator of Exchange 100 for the privilege of opting-in.

The opt-in process includes, in the illustrative embodiment, executing individual bi-lateral records exchange agreements between the MNO wishing to opt-in and other MNOs that have opted-in. The bi-lateral agreements control, among other issues, the amount/type of mobile-subscriber information that the MNOs will share with one another. In some other embodiments, records exchange agreements are “automatically” established once an MNO opts-in to Exchange 100. In yet some further embodiments, if exchange agreements are not established among one or more of the MNOs, a default agreement is used that permits some limited amount of information to be exchanged as between those MNOs.

In the illustrative embodiment, an Advertising Entity wishing to avail itself of the services provided by Mobile Advertising Exchange 100 must join the Exchange. In some embodiments, upon joining, the Advertising Entity pays a fee to the operator of Mobile Advertising Exchange 100.

In some embodiments, the operator of Exchange 100, in conjunction with MNOs, dictate to Advertising Entities the type of mobile subscriber information that is available for bid/purchase. In some other embodiments, the Advertising Entity and each MNO will negotiate the type of information that the Advertising Entity can receive about a particular MNO's subscribers. In some embodiments, an Advertising Entity pays a fee to an MNO for access to information about the MNO's subscribers, wherein the fee is a function of the amount/type of information that the Advertising Entity will receive. Any of a variety of arrangements can be used for deciding what information is available to an Advertising Entity and the manner of payment.

In some embodiments, a list—Participating Entity List 348—provides the identity of all MNOs and all Advertising Entities that have opted-in/joined Mobile Advertising Exchange 100. This identifier can be used to reference a specific party within Records 216.

As a consequence of strict confidentiality/privacy concerns and, in some cases, privacy laws, individual mobile subscribers “opt-in” to Mobile Advertising Exchange 100 in the illustrative embodiment. In other words, in the illustrative embodiment, even though a subscriber's home MNO has opted-in to Exchange 100, each mobile subscriber independently “opts-in,” thereby explicitly providing permission to the home MNO and Mobile Advertising Exchange 100 to share the subscriber's confidential records with other entities. In some other embodiments, an explicit opt-in is not performed (e.g., permission can be obtained outside the context of Mobile Advertising Exchange 100, or permission can be implicit in view of participation by the mobile subscriber in other services the home MNO provides, etc.). In some embodiments, Mobile Subscriber list 346 “identifies” all mobile subscribers that opt-in to Mobile Advertising Exchange 100. In some embodiments, List 346 will not explicitly reference the identity (i.e., the name) of the mobile subscriber. Rather, for example, List 346 includes the International Mobile Subscriber Identity (“IMSI”), Temporary Mobile Subscriber Identity (“TMSI”), or the like, or, alternatively, “de-identification technologies” can be used to protect the actual identity of any particular mobile subscriber.

As depicted in FIG. 3, at least some of the information contained in Records 216 is maintained within Secure Record Keeper (“SRK”) 330. In some embodiments, each MNO has its own SRK; in some other embodiments, each MNO has storage location allocated to it within a single “universal” SRK.

However conceptualized or implemented, SRK 330 is a secure region of processor-accessible storage 210. Security can be assured via any one or more of a number of means. For example, a dedicated link (or links) can be used (e.g., layer 1 physical or layer 2/3 virtual dedication) and/or L3 encryption, such as IPsec, can be used. In the illustrative embodiments, the SRK is further secured through data storage encryption, wherein each MNO holds the decryption key for its SRK (or portion thereof). In some other embodiments, data storage encryption can be used as an alternative to other types of security. In the illustrative embodiment, the decryption key is maintained by each MNO at the premises thereof. In further embodiments, the MNOs can store their decryption key within SRK 330. In some embodiments, the stored data is encrypted such that MNOs can prevent any other party from accessing its stored information.

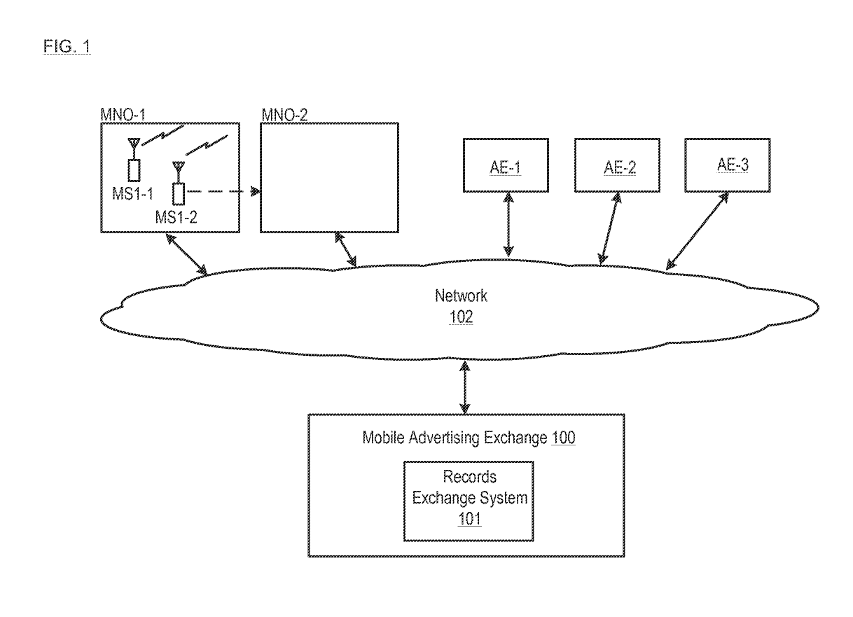

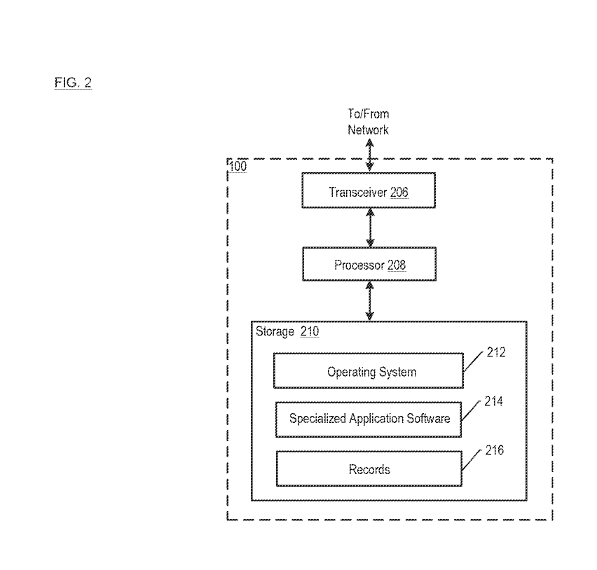

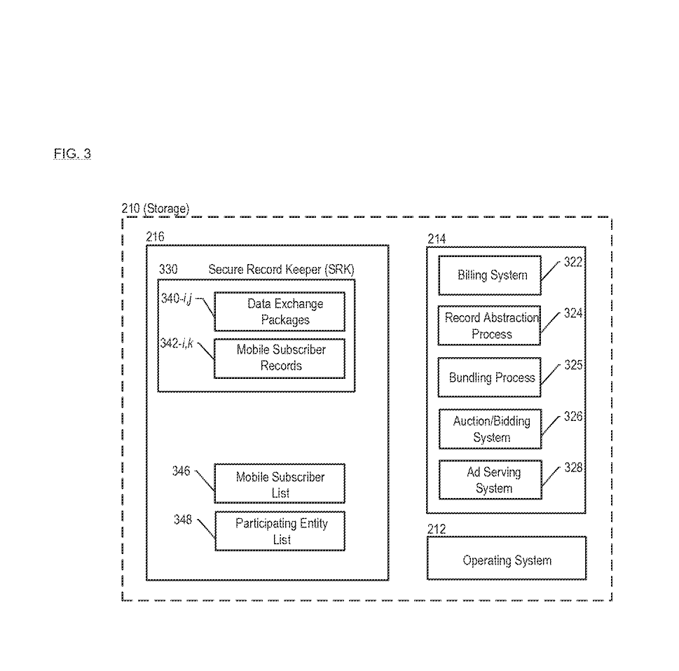

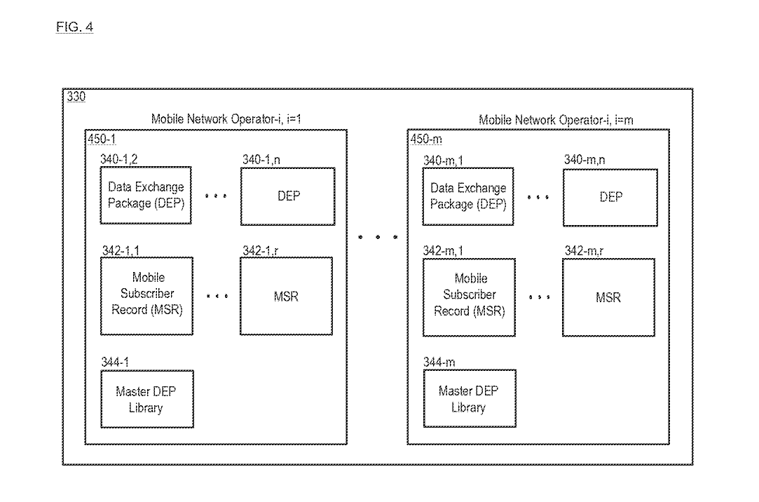

In the illustrative embodiment, the information stored in SRK 330 includes Data Exchange Packages (“DEPs”) 340-i,j and Mobile Subscriber Records (“MSRs”) 342-i,k. In some other embodiments, Mobile Subscriber List 346 is located within SRK 330. In some of such embodiments, each MNO maintains its own list of opted-in mobile subscribers; in some other of such embodiments, a single list of all opt-in mobile subscribers, irrespective of the home network thereof, is maintained in SRK 330. The information contained in DEPs 340-i,j and MSRs 342-i,k is discussed more fully below in conjunction with FIG. 4.

It is to be understood that terms such as “list,” “record,” “package,” etc., are used as a linguistic convenience and are not intended to specify or otherwise limit the manner in which the referenced information is stored or organized. For example, the use of such terms is not intended to require any particular data structure for the stored data. Also, reference to multiple (independent) lists—such as one for opted-in mobile subscribers and another for the MNOs and Advertising Entities—is not intended to mandate the use of multiple lists; a single list can be used, for example, for storing entities (both MNOs and Advertising Entities) and mobile subscribers. Indeed, one skilled in the art will understand that the information contained in processor-accessible storage 210 can be organized in any convenient manner.

Processor-accessible storage 210 also contains Specialized Application Software 214. In some embodiments, the Specialized Application Software includes, among other software, Billing System 322, Record Abstraction Process 324, Bundling Process 325, Auction/Bidding System 326, and Ad Serving System 328.

Billing System 322 comprises processor-executable instructions for apportioning, as appropriate, charges to the mobile subscriber for network access and usage, and fees for service usage, as between a number of different parties. Such parties include the mobile subscriber's home MNO, any other MNOs that the subscriber may have “visited” during the invoicing cycle, content providers, application service providers, Advertising Entities, and the like.

Billing System 322 also ensures that the operator(s) of Mobile Advertising Exchange 100 is compensated for the services the Exchange provides. This can be done in a variety of ways. In the illustrative embodiment, some portion of the applicable fees/charges otherwise owed to entities in the value chain is allocated, by Billing System 322, to Exchange 100.

Optional Auction/Bidding System 326 comprises processor-executable instructions for conducting an auction for an Advertising Package. System 326 is capable of receiving and evaluating bids and selecting a winning bidder.

Optional Ad-Serving System 328 comprises processor-executable instructions that enable the Mobile Advertising Exchange to serve an ad to a mobile subscriber on behalf of an Advertising Entity. The ad can be in the form of a mobile web banner (appearing at the top of a page), a mobile web poster (appearing at the bottom of a page), SMS advertising, MMS advertising, advertising within mobile games and videos, interstitials that appear while a requested item of mobile content or web page is loading, or a jingle before a voicemail recording.

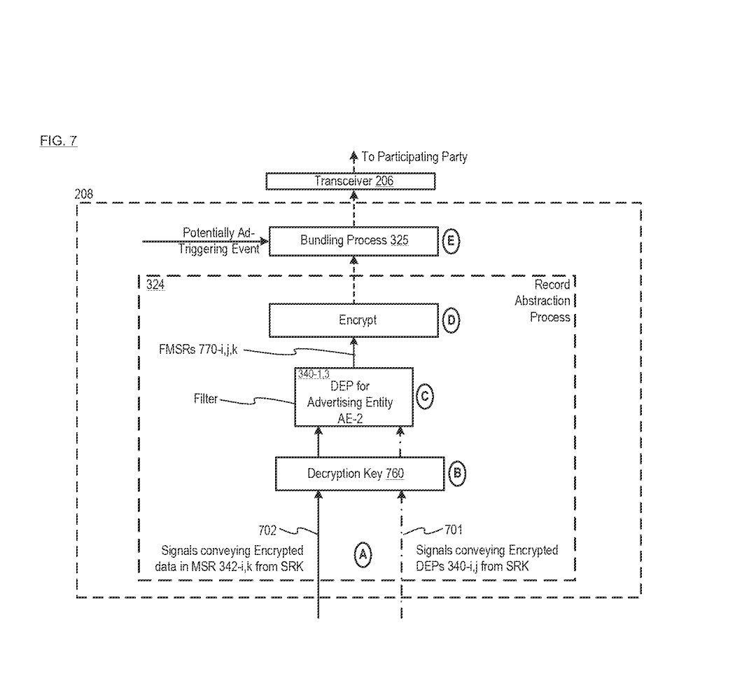

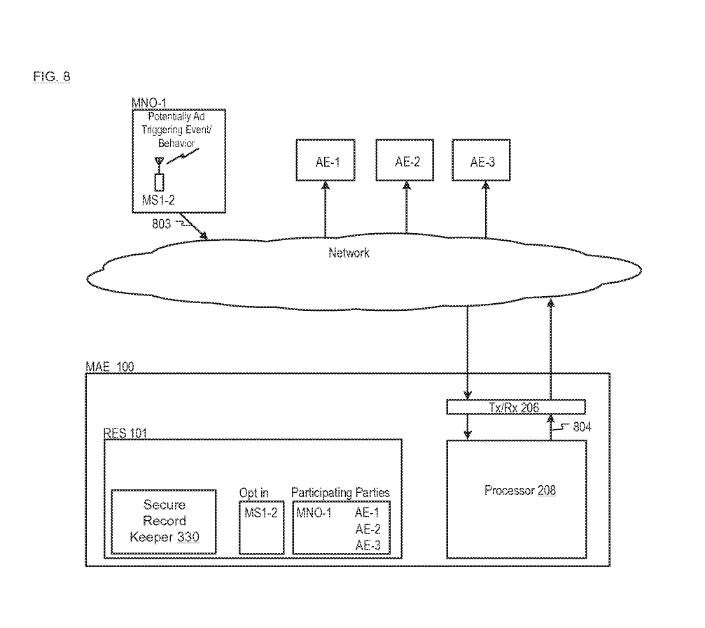

Record Abstraction Process (“RAP”) 324 comprises processor-executable instructions that generate “filtered” mobile subscriber records. In some embodiments, the basis for the filtering is a function of the intended recipient of the records. In particular, as between MNOs, the filtering is based on the records exchange agreement, as embodied in the Data Exchange Packages, between the home network (for the particular mobile subscriber) and the particular MNO that will be receiving the filtered mobile subscriber record. As between a MNO and an Advertising Entity, the filtering is based on whatever agreement, as embodied in the Data Exchange Packages, is in place as to what information a particular Advertising Entity is to receive. More particularly, Data Exchange Packages 340-i,j are used to filter the information pertaining to any given mobile subscriber, as contained in Mobile Subscriber Records (“MSR”) 342-i,k. The filtered information is typically a sub-set of the information contained in MSR 342-i,k. DEPs 340-i,j are discussed in more detail in conjunction with FIG. 4 and RAP 324 is discussed in more detail in conjunction with FIG. 7.

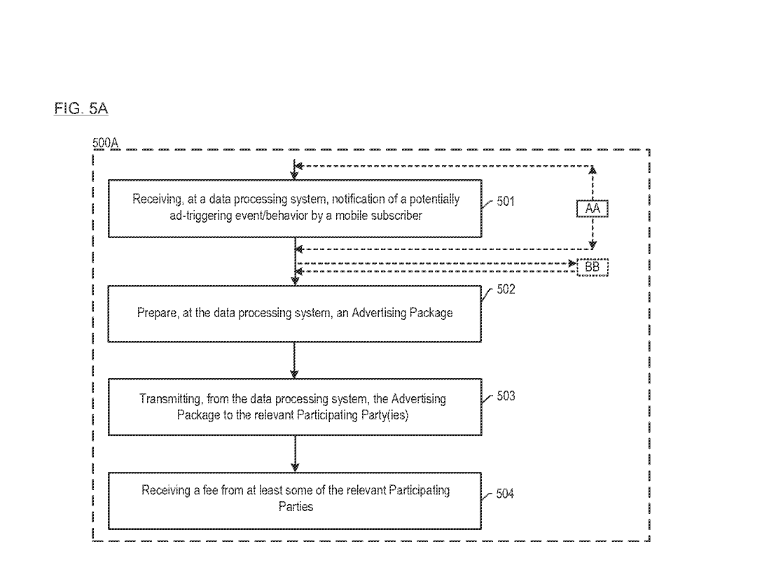

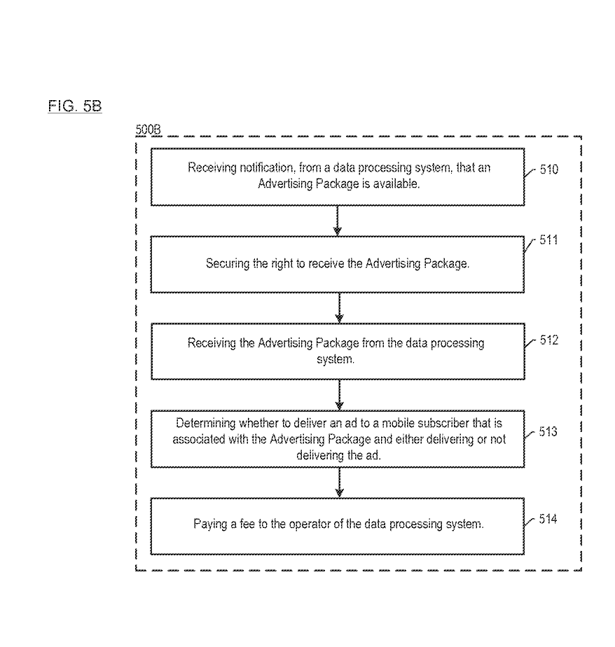

Bundling Process 325 combines filtered mobile subscriber records with information pertaining to a potentially ad-triggering event that results from certain mobile subscriber behavior. This is discussed in further detail in conjunction with FIGS. 5, 6D, and 7.

FIG. 4 depicts further detail of an illustrative embodiment of SRK 330. In the embodiment depicted in FIG. 4, the SRK comprises a plurality of storage blocks 450-i, each of which storage blocks contain:
a plurality of Data Exchange Packages 340-i,j wherein j=1,n
a plurality of Mobile Subscriber Records 342-i,k wherein k=1,r
Master Data Exchange Package Library 344-i.
   In this embodiment, each MNO-i has its own region of secure storage 450-i wherein i=1,m within SRK 330. The variable “i” is an identifier for the MNO (e.g., MNO-1, MNO-2, etc.). The variable “m” is the number of MNOs that have opted-in to Records Exchange System 100.

The data within a given storage block 450-i pertains to mobile subscribers of the associated MNO-i. Thus, from the perspective of those mobile subscribers, the associated MNO-i is the “home” MNO. For example, for storage block 450-1, the associated MNO is MNO-1 and the data in MSRs 342-1,k pertains to subscribers of MNO-1.

The information in MSRs 342-i,k is sourced from the home MNO of those subscribers. In accordance with the illustrative embodiment, under appropriate conditions (e.g., mobile subscriber opt-in, if necessary, etc.), subscriber information is transmitted from the home MNO to Mobile Advertising Exchange 100. The information that is transmitted is typically a subset of all information available about a mobile subscriber, such as is available in HLR/HSS of the MNO. As used in this Description and the appended claims, the term “selected mobile subscriber data” means a portion—that is, some but not all—of the information in the possession of the home MNO pertaining to a given mobile subscriber. The home MNO and/or each mobile subscriber and/or applicable law determines what types of information are acceptable to forward to Mobile Advertising Exchange 100. As such, in the illustrative embodiment, the mobile subscriber record 342-i,k comprises selected mobile subscriber data from the HLR/HSS and other records of the home MNO.

In the illustrative embodiment, each MNO-i has, in its SRK storage 450-i, MSRs for a number, “r,” of opt-in subscribers. In some other embodiments, MSRs are created for all mobile subscribers of the MNO, whether or not they opt-in. In such embodiments, if a mobile subscriber does not “opt-in,” then the MSR that contains the subscriber's information will not be accessed by RAP 324.

As noted above, an MNO's block of storage 450-i contains a plurality of DEPs 340-i,j wherein j=1,n. The variable “i” is an identifier for the associated MNO and “j” is an identifier for the entity that is to receive the information (e.g., Advertising Entity, etc.). In the illustrative embodiment, variable “j” is an absolute identifier (such as can be stored in Participating Entity List 348). That is, assuming that j=1 for MNO-1, DEPs in 450-1 would have indices DEP 340-1,j wherein j≠1. Similarly, for MNO-2, DEPs in 450-2 would have indices DEP 340-2,j wherein j≠2. In other embodiments, j is not a unique identifier.

The variable “n” is the sum of the number of MNOs that have executed record exchange agreements with a particular MNO-i and the number of Advertising Entities that have an agreement with the particular MNO-i. It is likely that at least some MNOs will not establish a data-exchange relationship with every other MNO using Records Exchange System 100 and some Advertising Entities will not establish an agreement with every MNO. As such, there may be a different number of DEPs 340-i,j within storage 450-i for different MNOs. In other words, the number “n” can vary from MNO to MNO.

The Data Exchange Packages or “DEPs” are rules packages that, in the illustrative embodiment, arise from (1) the records exchange agreement executed between the home network and each other MNO with which the home MNO is willing to share subscriber information and (2) agreements executed between the home network and Advertising Entities that wish to receive subscriber information.

As used in this Description and the appended claims, the term “Data Exchange Package” or “DEP” means:
(i) a set of rules, parameters, and/or guidelines that control what particular information about its mobile subscribers that the home network divulges to another MNO or an Advertising Entity; and optionally
(ii) a set of rules, parameters, and/or guidelines that control subscriber non-specific interactions between the home network and other MNOs.
   As explained further below, these rules, parameters, and/or guidelines can be in the form of memory addresses (e.g., in a subscriber's MSR, etc.) at which information that is to be “exchanged” (i.e., forwarded to another entity) can be found. As to item (i), the determination of what information is acceptable to divulge is determined by at least one of the following: the home network, the mobile subscriber, and applicable laws.

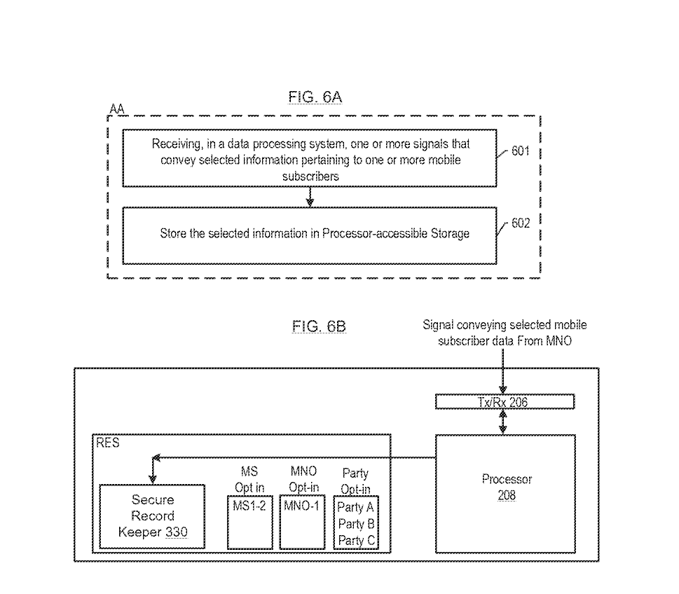

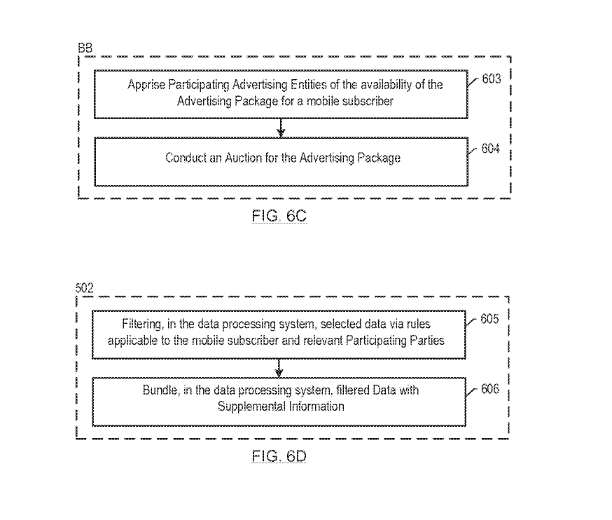

More particularly, and as discussed in further detail later in this specification, in conjunction with the Record Abstraction Process 324, the DEP “filters” information about a particular mobile subscriber, a class of mobile subscribers, or all opted-in mobile subscribers of a particular network. The intent is to generate a filtered record that contains information that a given entity needs or will otherwise be interested in, such as to make decisions as to whether or not to send an ad to a mobile subscriber's mobile phone. As such, in some embodiments, a given storage block 450-i of an MNO-i within SRK 330 might contain, for each MNO: (i) a different DEP for each mobile subscriber, (ii) different DEPs for different classes of subscribers (e.g., for subscribers age 12 and under, for subscribers age 13-17, and for subscribers age 18 or older, etc.), or (iii) a single DEP for all opt-in mobile subscribers of the home network. A particular DEP can apply to (i) a single MNO or a single Advertising Entity, (ii) a class of MNOs or Advertising Entities, or (iii) or all MNOs or all Advertising Entities. The content and filtering function of DEPs are discussed in further detail in conjunction with FIGS. 6 and 7.

FIG. 5A depicts a flow diagram of the salient tasks of method 500 for mobile advertising in accordance with the illustrative embodiment of the present invention. Method 500 is discussed in conjunction with FIGS. 6A-6D and 7.

In accordance with method 500 and task 501, Mobile Advertising Exchange System 100 receives notification of a “potentially ad-triggering event” originated by a mobile subscriber. In some embodiments, the potentially ad-triggering event is one of a number of occurrences that have been pre-defined by an Advertising Entity as “potentially ad-triggering.” Examples of such occurrences can be, for example and without limitation, the presence of a mobile subscriber at a certain location, a mobile subscriber scanning a bar code/QR code of a product, a mobile subscriber accessing a certain website, a mobile subscriber downloading certain software, a mobile subscriber doing on a search for a particular item/place, etc. As discussed further, the event is “potentially” ad triggering because, in the illustrative embodiment, the decision to actually send an ad to the mobile subscriber is not based solely on the event itself.

In some embodiments, the potentially ad triggering event is detected via the mobile subscriber's home MNO. Detection can be accomplished in any of a variety of ways, such as, for example and without limitation, detecting the use of particular APPS on the mobile subscriber's mobile device or via deep packet inspection. Upon detection, the home MNO checks the mobile subscriber's records to determine whether the subscriber has opted-in to receive mobile ads. The MNO captures information about the potentially ad-triggering event (e.g., the scanned code, a visited website, lat/long, etc.) and an “identifier” for the mobile subscriber and transmits at least this information to Mobile Advertising Exchange 100. The actual identity of the mobile subscriber is typically protected; the identifier is the Temporary Mobile Subscriber Identity (“TMSI”), or the like, or, alternatively, “de-identification technologies” can be used to protect the actual identity of any particular mobile subscriber.

Mobile Advertising Exchange 100 thus receives one or more signals that convey information about the potentially Ad-triggering event. These signals travel, for example, via network 102, and are received by transceiver 206, as previously discussed in conjunction with FIGS. 1 and 2.

Task AA is performed before or after task 501 performed in support of method 500. FIGS. 6A and 6B depict sub-tasks 601 and 602 of Task AA.

In sub-task 601 of Task AA, Records Exchange System 101 of Mobile Advertising Exchange 100 receives selected mobile subscriber data about one or more mobile subscribers of a particular MNO. In some embodiments, the data pertains to all mobile subscribers that have “opted-in” to the Record Exchange System. In such embodiments, the selected mobile subscriber data is sent to the Mobile Advertising Exchange before the potentially ad-trigger event occurs. In some other embodiments, the selected mobile subscriber data pertains to the mobile subscriber that is responsible for the potentially ad-triggering event. That data is sent, of course, after the potentially ad-triggering event occurs.

Per sub-task 602, processor 208 causes the received selected mobile subscriber data to be stored in processor-accessible storage 210. More particularly, and with reference now to FIG. 6B, processor 208 extracts selected mobile subscriber data from the received signal and conveys it to the appropriate storage block 450-i in SRK 330 (see FIG. 4). Due to the typically highly confidential nature of at least some of selected information, its security should be assured as previously discussed. In the illustrative embodiment, the mapping operations by which the records are configured for storage is provided by the MNO or appropriate software operating on processor 208. In conjunction with this Detailed Description, those skilled in the art will know how to process the selected mobile subscriber records for storage in SRK 330.

In some other embodiments (typically those in which the selected data for only a single subscriber is transmitted), the selected mobile subscriber data is not archived in processor-accessible storage 210. Although considered to be optional, sub-task 602 is advantageous and is performed in preferred embodiments of the method.

In the illustrative embodiment, after accomplishing tasks 501 and AA, optional task BB is performed. FIG. 6C depicts sub-tasks 603 and 604 of optional task BB.

Sub-task 603 recites apprising Advertising Entities of the availability of the Advertising Package for one or more mobile subscribers. In some embodiments, Mobile Advertising Exchange 100 transmits a message to Advertising Entities of the availability of the Advertising Package and optionally some accompanying basic information about the subscriber. The information is intended to assist the Advertising Entity in determining whether it has an interest in the Advertising Package.

In accordance with sub-task 604, an auction is conducted for the Advertising Package, wherein interested Advertising Entities submit bids in the hope of winning the auction and gaining access to the Advertising Package.

Returning to the discussion of method 500A, in task 502, the Advertising Package is prepared. It is notable that in the illustrative embodiment in which an auction is conducted for the Advertising Package, it is efficient to prepare the Advertising Package after the winning bidder for the Advertising Package has been awarded. This minimizes processing requirements, since the processing described below in conjunction with FIGS. 6D and 7 would be performed for only a single (i.e., the winning) Advertising Entity.

FIGS. 6D and 7 depict sub-tasks 605 and 606, which are performed in support of task 502. These tasks involve filtering the appropriate mobile subscriber record(s) and then optionally bundling the filtered record, as appropriate, with information pertaining to the potentially ad-triggering event. For example, if a mobile subscriber scans the bar code of a product with a mobile device, the bar code might be bundled with the filtered record. In support of sub-task 605, processor 208 extracts and/or determines, from the information contained in the signal(s) received at task 501 of method 500A, the home MNO of the mobile subscriber. Also, the processor determines which data exchange package(s) (DEPs) should be accessed by RAP 324. That determination is a function of at least: (i) the “identity” of the mobile subscriber and (ii) the advertising entities that are to receive the advertising package.

Per sub-task 605 of task 502, the selected mobile subscriber data pertaining to the mobile subscriber associated with the potentially ad-triggering event is filtered in accordance with various parameters and rules, as embodied in the Data Exchange Packages governing the interactions between the subscriber's home MNO, the mobile subscribers, other MNOs, and Advertising Entities.

FIG. 7 depicts an embodiment of Record Abstraction Process 324 wherein filtered mobile subscriber records are generated using DEPs. As previously disclosed, RAP 324 is a specialized software application, executing in processor 208, for use in conjunction with Records Exchange System 101 of Mobile Advertising Exchange 100.

FIG. 7 depicts tasks A through D being performed by RAP 324 for a mobile subscriber of MNO-1. In that regard, there is a discrete instantiation of the RAP for each MNO-i. It is assumed that an auction was conducted and the auction was awarded to Advertising Entity AE-2.

In accordance with task A, the RAP causes the DEP for AE-2, which is 340-1,3, as stored in storage block 450-1 (for MNO-1) in SRK 330, to be copied (into registers that are available) to processor 208. Signal(s) 701 convey the copied DEP from processor-accessible storage 210 to processor 208. In some embodiments, the DEP is encrypted. In such embodiments, the DEP is decrypted via the MNO's decryption key 760, as per task B. Per task A, RAP 324 also causes a copy of the appropriate mobile subscriber record(s) MSR 342-1,k, as stored in the MNO-1 storage block 450-1 in SRK 330, to be transmitted to processor 208. Signal(s) 702 convey the copied mobile subscriber record(s) MSR 342-1,k from processor-accessible storage 210 to processor 208. In the illustrative embodiment, the MSR is encrypted, so, at task B, MSR 342-1,k is decrypted via decryption key 760 of MNO-1.

At task C, the mobile subscriber record(s) 342-1,k is “filtered” by DEPs 340-1,3 for Advertising Entity AE-2 to generate filtered mobile subscriber records (“FMSR”) 770-i,j,k. The DEP 340-i,j can be conceptualized as a “comb” filter that (i) filters the mobile subscriber record and, in some embodiments, (ii) also filters a master set of usage rules established by the home MNO.

Continuing with the “filter” metaphor, and with respect item (i), the subscriber information contained within MSR 342-1,k (i.e., all data pertaining to mobile subscriber k that the home MNO (i.e., MNO-1) has provided to System 100) is presented to a filter, as embodied by DEP 340-1,j. The DEP permits only certain information (i.e., information that is deemed acceptable to forward to Advertising Entity AE-2) within MSR 342-1,k to “pass.” As such, FMSR 770-i,j,k typically contains a sub-set of the subscriber information for subscriber k contained in MSR 342-i,k. As used in this Description and the appended claims, the term “Filtered Mobile Subscriber Record” means a record generated from the selected mobile subscriber records by “filtering” it, as that term is used herein, via a DEP.

It will be understood that the DEP does not actually filter the data in the manner shown; this is a metaphor. It is more appropriate to describe the operation of the DEP as “extracting” information from the mobile subscriber records. For example, in some embodiments, the DEP 340-1,3 provides the storage locations for information from mobile subscriber records 342-i,k that are to be copied into record FMSR 770-i,j,k destined for Advertising Entity AE-2. These or other arrangements for implementing DEPs, as will occur to those skilled in the art after reading this specification, may suitably be used.

As previously mentioned, DEPs can also function as a “filter” for “usage” rules. These usage rules involve, for example, certain policies that the (home) MNO wishes to apply to other MNOs. For example, the DEP might extract information from an MSR 342-i,k that dictates, for example, certain actions that the visited MNO must take (or cannot take) with respect to all subscribers from the particular home network that roam into that particular MNO or certain information that the visited MNO must provide to the home MNO. In such an embodiment, the home MNO establishes master DEP library 344-i in its storage block 450-i within SRK 330. After reading this specification, those skilled in the art will be able to implement alternative embodiments in which a master DEP is not employed and usage rules applicable for an MNO are obtained in a different manner.

It will be appreciated that although the DEPs are, in the illustrative embodiment, based on information exchange agreements between a (home) MNO and various other entities, it is advantageous for Records Exchange System 101 of Mobile Advertising Exchange 100 to actually create the DEPs using the information contained in the agreements. This is appropriate since to “filter” a mobile subscriber record, the DEPs and RAP 324 must have requisite information concerning the precise storage locations of particular types of information within the subscriber's MSR as well as other detailed processing information.

In accordance with the illustrative embodiment, at task D, FMSRs 770-i,j,k are encrypted. The encryption can be the same as applied to the records kept in the MNO's storage block 450-i. Alternatively, a different encryption scheme implemented by Records Exchange System 101 can be applied at task D.

It is to be understood that the order of tasks A through D is permutable and, furthermore, not all tasks are required in all embodiments. After reading this disclosure, those skilled in the art will be able to make and use RAP 324 and the DEPs.

Sub-task 606 of task 502 recites bundling the filtered data with supplemental information. The supplemental information can be, for example, information pertaining to the potentially ad-triggering event. For example, if a mobile subscriber scans the bar code of a product with a mobile device, the bar code might be bundled with the filtered record. Sub-task 606 is depicted in FIG. 7 as task E.

Returning once again to method 500A of FIG. 5, task 503 recites transmitting the Advertising Package to the relevant Advertising Entities. With reference again to FIG. 7, this task 505 is implemented as transceiver 206 transmits one or more signal(s) to appropriate Advertising Entities, thereby conveying the Advertising Package thereto.

In some embodiments, rather than conducting an auction per optional task BB, Advertising Entities pay in advance to receive Advertising Packages that meet certain requirements (e.g., subscriber demographics, subscriber interest, etc.). In such embodiments, the Advertising Package is simply transmitted to the Advertising Entity.

If the mobile subscriber is being serviced by its home MNO when the potentially ad-triggering event occurs, then there is no need for filtered mobile subscriber data to be transmitted to any other MNO (unless the MNO is an advertiser).

Task 504 of method 500A recites that the operator of Mobile Advertising Exchange 100 receives a fee for its services from at least some of the entities using the Exchange.

FIG. 5B depicts method 500B by which an Advertising Entity interacts with the Mobile Advertising Exchange in some embodiments. In accordance with task 510, an Advertising Entity receives notification from the Mobile Advertising Exchange that an Advertising Package associated with a particular mobile subscriber is available. As previously discussed, the notification is the result of a mobile subscriber having caused a potentially ad-triggering event.

Task 511 recites that the Advertising Entity secures the right to receive the Advertising Package. In some embodiments, this is accomplished by submitting a winning bid in an auction for the Advertising Package. In some other embodiments, the right is secured by the payment of a fee, in advance, to receive an Advertising Package for certain “classes” of mobile subscribers (e.g., those that exhibit certain behaviors, etc.).

In accordance with task 512, the Advertising Entity receives the Advertising Package from the Mobile Advertising Exchange. As previously discussed, the information contained in the Advertising Package includes filtered mobile subscriber records and, optionally, information pertaining to a potentially ad-triggering event.

Based on the Advertising Package, the Advertising Entity determines whether it wishes to deliver an ad to the associated mobile subscriber per task 513. The Advertising Entity then either delivers the ad, or not, depending upon the determination. In some embodiments, the Mobile Advertising Exchange or other party (not the particular Advertising Entity) delivers the ad.

In accordance with task 514, the Advertising Entity pays a fee to the operator of the Mobile Advertising Exchange. In some embodiments, the fee, or a portion thereof, is paid before receiving an Advertising Package. In some other embodiments, the fee, or a portion thereof, is paid when the Advertising Entity receives an Advertising Package from the Mobile Advertising Exchange.

FIGS. 8 through 12 depict an example of using Mobile Advertising Exchange 100 to provide targeted mobile advertising.

Referring now to FIG. 8. MNO-1 and advertising entities AE-1, AE-2, and AE-3 have opted-in to System 100 in the manner previously discussed and as further detailed in U.S. patent application Ser. No. 13/724,956. MNO-1 has many mobile subscribers; subscriber MS1-2 is one such subscriber that has opted-in to the Mobile Advertising Exchange. Selected mobile subscriber records for MS1-2 are assumed to have been conveyed to Records Exchange System 101 of the Mobile Advertising Exchange and stored in secure record keeper 330.

Subscriber MS1-2 has engaged in a potentially ad-triggering event. When this occurs, home network operator MNO-1 checks its records to see if subscriber MS1-2 has opted-in. If so, then MNO-1 sends signal 803 to Mobile Advertising Exchange 100 advising the Exchange that subscriber MS1-2 has engaged in a potentially ad-triggering event.

Transceiver 206 receives the signal transmitted by the Mobile Advertising Exchange and transmits it to processor 208. The processor extracts, from the signal, information about the potentially ad-triggering event, such as, without limitation, the mobile subscriber, and/or the home MNO of the subscriber, and/or information pertaining to the event. Processor 208 generates and transmits signal 804, to relevant advertising entities, such as advertising entities AE-1, AE-2, and AE-3, which advises the Advertising Entities of that an Advertising Package for subscriber MS1-2 is available and, in this example, is to be auctioned to the highest bidder. In this example, signal 804 contains some information about at least one of either the potentially ad-triggering event or the mobile subscriber so that the Advertising Entity can determine whether it wishes to bid for the associated Advertising Package.

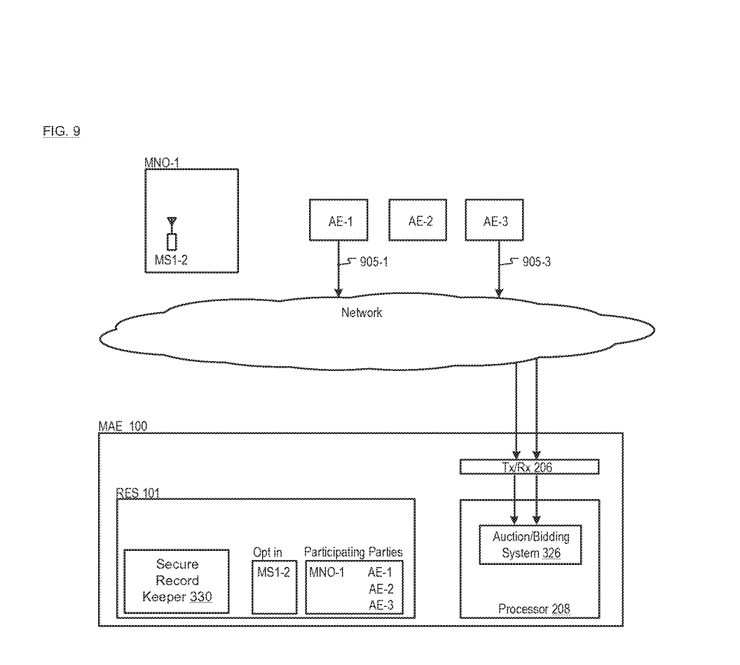

FIG. 9 depicts Advertising Entities AE-1 and AE-3 submitting bids, via respective signals 905-1 and 905-3, to the Mobile Advertising Exchange; Advertising Entity AE-2 chose not to bid. Processor 208 conducts the auction running the auction/bidding system 326 and awards the auction to the highest bidder. In this example, the auction was awarded to Advertising Entity AE-3.

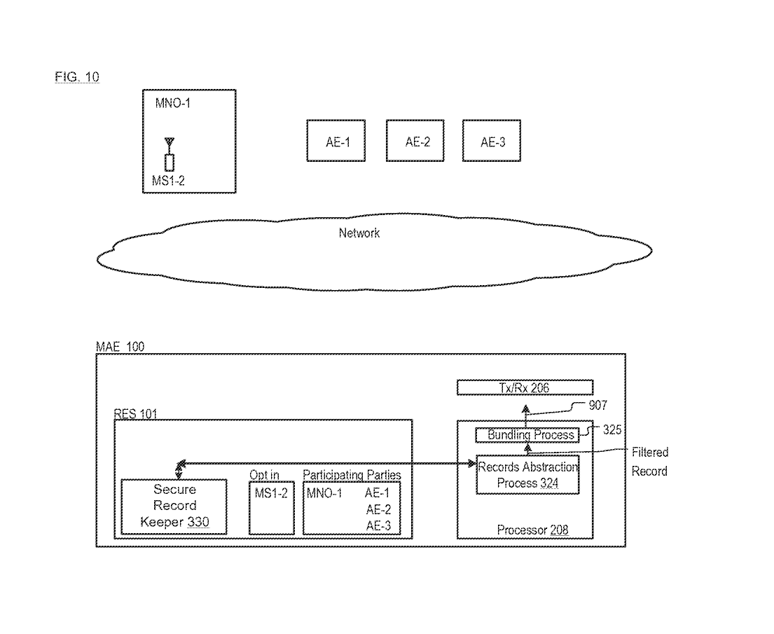

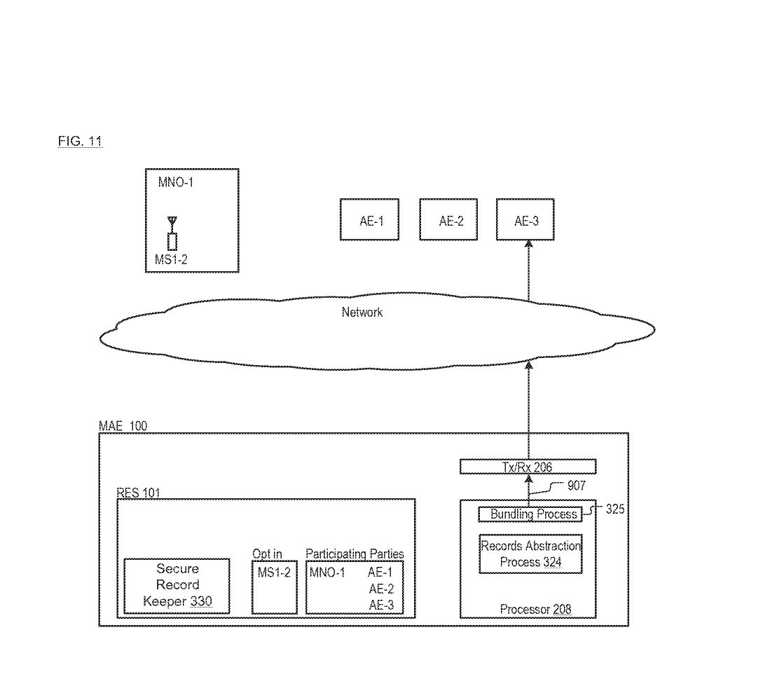

FIG. 10 depicts Mobile Advertising Exchange 100 generating Advertising Package 907 for transmission to Advertising Entity AE-3. As depicted, Records Abstraction Process 324 is used to generate a filtered mobile subscriber record, by applying the appropriate DEP. As previously discussed in conjunction with FIG. 7, this involves transmitting to processor 208, one or more DEP(s) applicable to MNO-1, AE-3 and MS1-2. Also, one or more mobile subscriber records for MS1-2 are transmitted to processor 208. As applicable, a decryption key is copied into RAP 324 as well. The filtered record is then bundled with information pertaining to the potentially ad-triggering event to generate Advertising Package 907.

FIG. 11 depicts transceiver 206 transmitting Advertising Package 907 to Advertising Entity AE-3.

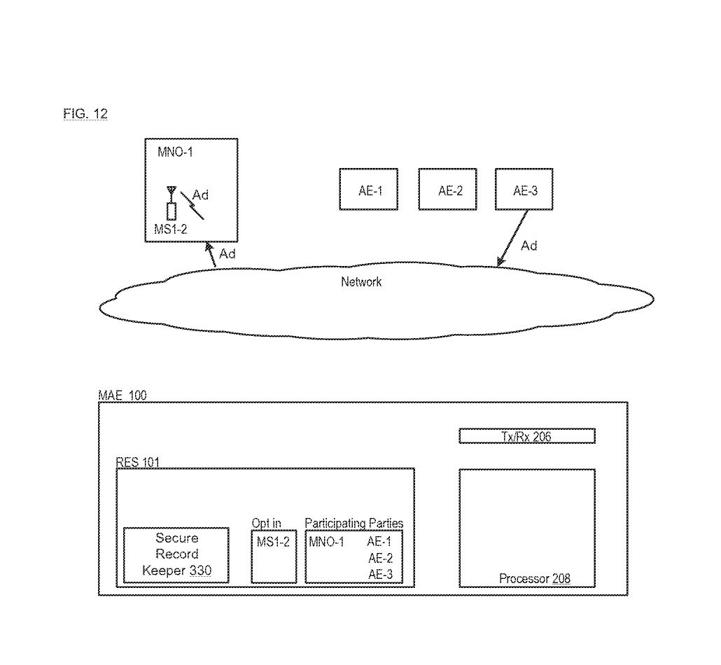

FIG. 12 depicts Advertising Entity AE-3 publishing an ad to mobile subscriber MS1-2. The ad can be a mobile web banner (appearing at the top of a page), a mobile web poster (appearing at the bottom of a page), SMS advertising, MMS advertising, advertising within mobile games and videos, interstitials that appear while a requested item of mobile content or web page is loading, or a jingle before a voicemail recording.

In some other embodiments, Advertising Entity AE-3 can direct Mobile Advertising Exchange 100 to publish the ad via optional Ad-Serving System 328. In yet some additional embodiments, a third party published can publish the ad to the mobile subscriber.

Mobile Advertising Exchange 100 receives a fee from Advertising Entities. In some embodiments, the Advertising Entity pays a fee to the Exchange upon opt-in and/or as a consequence of submitting a winning bid for an Advertising Package.

The example depicted in FIGS. 8 through 12 is for a situation in which the mobile subscriber remains in the home MNO. As previously noted, Mobile Advertising Exchange 100 can also be used when a mobile subscriber roams to another mobile network. In such a situation, filtered records are delivered to the visited MNO as well as the Advertising Entity (assuming that they are different). For adapting Mobile Advertising Exchange 100 and associated methods for use in visited networks, see co-pending U.S. patent application Ser. No. 13/757,100 entitled “Records Exchange System and Method for Mobile Broadband Roaming,” which is incorporated by reference herein.

It is to be understood that many variations of the invention can easily be devised by those skilled in the art after reading this disclosure and that the scope of the present invention is to be determined by the following claims.

What is claimed is:

1. A method comprising:
receiving, at a data processing system, notification of a potentially ad-triggering event associated with a mobile subscriber who is associated with a first mobile network;
generating, in the data processing system, an advertising package, wherein the advertising package includes first filtered mobile subscriber data pertaining to the mobile subscriber;
transmitting, from the data processing system, the advertising package to at least one of a first advertising entity and a second advertising entity; and
receiving, at the data processing system, a first fee from at least the one advertising entity to which the advertising package is transmitted.

2. The method of claim 1 wherein the notification comprises a scan of a bar code or a QR code associated with a product.

3. The method of claim 1 and further comprising determining, in the data processing system, whether the advertising package is to be transmitted to the first advertising entity, the second advertising entity, or both of the first and second advertising entity.

4. The method of claim 3 wherein the task of determining further comprises conducting an auction, in the data processing system, for the advertising package.

5. The method of claim 4 and further wherein prior to conducting the auction, notifying the first advertising entity and a second advertising entity that the advertising package will be auctioned.

6. The method of claim 4 wherein conducting the auction further comprises:
receiving, at the data processing system, a bid for the advertising package from the first advertising entity;
receiving, at the data processing system, a bid for the advertising package from a second advertising entity; and
awarding the auction to one of the first advertising entity and the second advertising entity.

7. The method of claim 3 and further comprising receiving, at the data processing system, information from the first advertising entity, wherein the information defines a first class of mobile subscribers of interest to the first advertising entity from the perspective of delivering ads thereto.

8. The method of claim 7 and further comprising determining that the advertising package is to be transmitted to the first advertising entity because the mobile subscriber falls within the first class of mobile subscribers.

9. The method of claim 7 and further comprising receiving, at the data processing system, information from the second advertising entity, wherein the information defines a second class of mobile subscribers of interest to the second advertising entity from the perspective of delivering ads thereto.

10. The method of claim 9 and further comprising determining that the advertising package is to be transmitted to the first advertising entity and the second advertising entity because the mobile subscriber falls within the first class of mobile subscribers and the second class of mobile subscribers.

11. The method of claim 3 wherein it is determined that the advertising package is to be transmitted to the first advertising entity, the method further comprising generating the first filtered mobile subscriber data using a first data exchange package pertaining to the first advertising entity.

12. The method of claim 11 further comprising transmitting, to the data processing system from the first mobile network, mobile subscriber data pertaining to the mobile subscriber, wherein the mobile subscriber data is used in conjunction with the first data exchange package to generate the first filtered mobile subscriber data.

13. The method of claim 1 and further comprising subsidizing a service that the mobile subscriber receives from the first mobile network based on the first fee or a second fee paid by the first advertising entity.

14. The method of claim 1 wherein the mobile subscriber leaves the first mobile network and enters a region wherein wireless service is provided by a second mobile network, the method further comprising:
generating, in the data processing system, second filtered mobile subscriber data, wherein the first filtered mobile subscriber data and the second filtered mobile subscriber data are different from one another; and
transmitting, from the data processing system, the second filtered mobile subscriber data to the second mobile network.

15. The method of claim 1 further comprising receiving, at the data processing system, a command from at least one of the first advertising entity and the second advertising entity to deliver an ad to a mobile device of the mobile subscriber.

16. A mobile advertising exchange comprising a data processing system, wherein the data processing system includes:
a transceiver for sending signals to and receiving signals from a first mobile network and at least one of a first advertising entity and a second advertising entity; and
a processor, wherein the processor:
(i) extracts information, sourced from the first mobile network, pertaining to a potentially ad-triggering event associated with a mobile subscriber of the first mobile network;
(ii) generates an advertising package comprising first filtered mobile subscriber data;
(iii) causes the transceiver to transmit the advertising package to at least one of the first advertising entity and the second advertising entity; and
(iv) generates at least one invoice that requires at least one of the first advertising entity and the second advertising entity to pay a fee to an operator of the mobile advertising exchange.

17. The mobile advertising exchange system of claim 16 and further wherein the processor determines that the advertising package is to be transmitted to the first advertising entity.

18. The mobile advertising exchange system of claim 17 and further wherein the processor conducts an auction to determine that the advertising package is to be transmitted to the first advertising entity.

19. The mobile advertising exchange of claim 18 and further wherein the processor transmits a message to the first advertising entity and the second advertising entity, wherein the message indicates that the advertising package will be auctioned to a highest bidder.

20. The mobile advertising exchange of claim 16 and further wherein the processor generates the first filtered mobile subscriber data using a first data exchange package pertaining to the first advertising entity and selected mobile subscriber data that is received from the first mobile network.

21. The mobile advertising exchange of claim 16 wherein the processor bundles the first filtered mobile subscriber data with information pertaining to the potentially ad-triggering event to generate the advertising package.

22. The mobile advertising exchange of claim 14 wherein the processor:
(v) receives a request from the first advertising entity to transmit an ad to the mobile subscriber; and
(vi) transmits an ad to the mobile subscriber.
